(19) United States
(12) Patent Application Publication
(10) Pub. No.: US 2023/0134519 A1
(43) Pub. Date: May 4, 2023

(54) Protective Liner Coating

(71) Applicant: Mascorp, Ltd., Houston, TX (US)

(72) Inventors: George Hall More, Houston, TX (US); Jim Jackson Milham Henry, Houston, TX (US); Thomas Wulfing Fitzgerald, JR., Smiley, TX (US)

(73) Assignee: Mascorp, Ltd., Houston, TX (US)

(21) Appl. No.: 17/517,021

(22) Filed: Nov. 2, 2021

(51) Int. Cl. C09D 7/48; C09D 153/02; C09D 167/00; C09D 7/20; C09D 7/61; C09D 7/63; C09D 7/40

(52) U.S. Cl. CPC C09D 7/48; C09D 153/02; C09D 167/00; C09D 7/20; C09D 7/61; C09D 7/63; C09D 7/69; C09D 7/70

(57) ABSTRACT

The present invention relates to a protective liner coating. The protective liner coating may comprise one or more solvents, an antioxidant, a first pigment, barium sulfate, a wetting agent, a rheological additive, a surfactant, a second pigment, and a plurality of resins. The protective liner coating may be used for secondary containment protection from chemicals and other toxic substances.

### BACKGROUND

### 1. Field of Inventions

The field of this application and any resulting patent is protective liner coatings for secondary containment protection from chemicals and other toxic substances.

### 2. DESCRIPTION OF RELATED ART

Various coatings have been proposed and utilized for secondary containment protection, including some of the coatings disclosed in the references appearing on the face of this patent. However, those coatings lack all the features of the coatings covered by any patent claims below. As will be apparent to a person of ordinary skill in the art, any coatings covered by claims of the issued patent solve many of the problems that prior art coatings have failed to solve. Also, the coatings covered by at least some of the claims of this patent have benefits that could be surprising and unexpected to a person of ordinary skill in the art based on the prior art existing at the time of invention.

In the area of industrial secondary containment, chemical plants, mining operations, water treatment plants, and other industrial operations are generally required to meet secondary containment requirements, which are addressed by the Environmental Protection Agency (EPA) through the Resource Conservation and Recovery Act (RCRA) contained in 40 C.F.R. § 264, the 2006 Uniform Fire Code (UFC) in standard 60.3.2.8.3, and in the 2006 International Fire Code (IFC) in 2704.2. These requirements are known to those of ordinary skill in the art.

Current products on the market include epoxies and vinyl esters applied to containment areas. These products lack flexibility, impermeability (due to brittle fracture properties), toughness, and ease of application. For example, their application is typically complicated due to two or three-part type coating systems, and their pot life is limited due to catalyzation requirements. Epoxies and vinyl esters fail because they crack along with the concrete secondary containment surface, which is due to their brittle fracture properties and lack of flexibility, allowing hazardous contaminants to migrate into the subsoil, ground, and/or surface water, through the broken concrete.

Additionally, epoxies are low in elongation: 2.5% to 6.5%. Elongation is a measure of material ductility, which is a specific coating's ability to undergo significant plastic deformation before rupture. A coating's yield elongation is the maximum stress the material will sustain before fracture. Elongation, when expressed as a percentage, shows how much bigger the material is after deformation has completed. Elongation is more commonly known as “flexibility.” For example, Novolacs (a family of epoxy technology) consisting of a two-component system may be resistant to chemical attacks, but they lack suitable elongation to provide long term wearability, especially in concrete secondary containment surface protection. Concrete, due to its properties and nature, will always crack causing Novolacs and vinyl ester coatings to crack as well, creating possible environmental subsurface intrusion of the hazardous chemicals seeping through the broken concrete and creating secondary containment failure leading to soil and ground water contamination. Additionally, both Novolacs and vinyl esters require extensive labor to apply due to the fast exothermic reaction when the A side (resin side) and B side (hardener side) are mixed. Further, their pot lives are roughly 20 to 30 minutes, requiring multiple crews of up to 10 to 12 people to quickly apply Novolacs or vinyl esters before the coating cures or hardens in the pot. Also, when applying Novolacs two-component epoxies to concrete secondary containment surfaces, attention must be paid to each and every expansion joint. The typical practice is to apply a geotextile or woven fiberglass mesh pressed into the joint. The epoxy coating is then typically applied by either spraying, brushing, troweling, or rolling the coating into the joints and substrates. Thus, there is a need for a flexible, single-component, monolythic coating that is designed to provide secondary containment protection of concrete structures from harsh chemicals and other toxic substances.

The embodiments of coatings disclosed herein satisfy this need with their properties of high elongation (varying from 153% to 450% depending on customer requirements) as well as chemical and UVA resistance, specifically for containment areas. The embodiments disclosed herein also provide substrate adhesion, flexibility, impermeability, water resistance, adhesiveness, electrical resistance, toughness, ease of application, and long pot life. Further, the embodiments disclosed herein may endure heavy truck traffic and abrasion from equipment movement or relocation while maintaining protection of the concrete structures.

### SUMMARY

One or more specific embodiments disclosed herein includes a protective liner coating comprising a first solvent, wherein the first solvent comprises C9-C11 aromatic hydrocarbons; a second solvent, wherein the second solvent comprises a nature-based terpene solvent; a third solvent; an antioxidant; a first pigment, wherein the first pigment comprises an inorganic pigment; barium sulfate; a wetting agent, wherein the wetting agent comprises modified polyacrylate fluorocarbon-modified polymers; a rheological additive, wherein the rheological additive comprises attapulgite clay; a surfactant, wherein the surfactant comprises a non-reactive silicone glycol copolymer surfactant; a second pigment, wherein the second pigment comprises a liquid pigment; and a plurality of resins.

One or more specific embodiments disclosed herein includes a protective liner coating comprising a first solvent having a wt. % in the range of 10 wt. % to 15 wt. %; a second solvent having a wt. % in the range of 10 wt. % to 15 wt. %; a third solvent; an antioxidant having a wt. % in the range of 0.30 wt. % to 0.50 wt. %; a first pigment having a wt. % in the range of 10 wt. % to 15 wt. %; barium sulfate having a wt. % in the range of 10 wt. % to 15 wt. %; a wetting agent having a wt. % in the range of 0.8 wt. % to 1.0 wt. %; a rheological additive having a wt. % in the range of 0.10 wt. % to 0.20 wt. %; a surfactant having a wt. % in the range of 0.4 wt. % to 0.6 wt. %; a second pigment having a wt. % in the range of 0.10 wt. % to 0.25 wt. %; and a plurality of resins having a wt. % in the range of 24 wt. % to 28 wt. %.

One or more specific embodiments disclosed herein includes a method for making a protective liner coating comprising providing a tank and a mixer; adding a first solvent and a second solvent to the tank; mixing the first solvent and the second solvent in the tank; adding the following additional materials to the tank: an antioxidant, a first pigment, barium sulfate, a wetting agent, a rheological additive, a surfactant, and a second pigment; adding a plurality of resins to the tank; and adding a third solvent to the tank.

### BRIEF DESCRIPTION OF THE DRAWINGS

FIG. 1 is a black-and-white photograph of a sample of a protective liner coating embodiment after exposure to 98% sulfuric acid.

FIG. 2 is a black-and-white photograph of a sample of a protective liner coating embodiment after exposure to pH 5.7 carbonic acid.

FIG. 3 is a black-and-white photograph of a sample of a protective liner coating embodiment after exposure to 70% sulfuric acid.

FIG. 4 is a black-and-white photograph of a sample of a protective liner coating embodiment after exposure to 80% sulfuric acid.

FIG. 5 is a black-and-white photograph of a sample of a protective liner coating embodiment after exposure to 95% formic acid.

FIG. 6 is a black-and-white photograph of a sample of a protective liner coating embodiment after exposure to 60% sulfuric acid.

FIG. 7 is a black-and-white photograph of a sample of a protective liner coating embodiment after exposure to 33.2% sulfuric acid.

FIG. 8 is a black-and-white photograph of a sample of a protective liner coating embodiment after exposure to 99% acetic acid.

FIG. 9 is a black-and-white photograph of a sample of a protective liner coating embodiment after exposure to 50% sodium hydroxide.

FIG. 10 is a black-and-white photograph of a sample of a protective liner coating embodiment after exposure to 31.5% hydrochloric acid.

FIG. 11 is a black-and-white photograph of a sample of a protective liner coating embodiment after exposure to 37% hydrochloric acid.

FIG. 12 is a black-and-white photograph of a sample of a protective liner coating embodiment after exposure to 85% phosphoric acid.

FIG. 13 is a black-and-white photograph of a sample of a protective liner coating embodiment after exposure to 31.5% hydrochloric acid.

FIG. 14 is a black-and-white photograph of a sample of a protective liner coating embodiment after exposure to 50% sodium hydroxide.

FIG. 15 is a black-and-white photograph of a sample of a protective liner coating embodiment after exposure to methanol.

FIG. 16 is a black-and-white photograph of a sample of a protective liner coating embodiment after exposure to 99% acetic acid.

FIG. 17 is a black-and-white photograph of a sample of a protective liner coating on coated concrete taken after the performance of a concrete adhesion test.

FIG. 18 is a black-and-white photograph of concrete panels coated with a sample of a protective liner coating, which shows the effects of five years of outdoor UV exposure.

FIG. 19 is a black-and-white photograph of a coated Q-Panel after 227 days of exposure from a QUV accelerated weathering test.

FIG. 20 is a black-and-white photograph of a sample of a protective liner coating embodiment after long-term exposure to 10%, 20%, and 30% sodium hydroxide.

FIG. 21 is a black-and-white photograph of a sample of a protective liner coating embodiment after long-term exposure to 10% and 20% hydrochloric acid.

FIG. 22 is a black-and-white photograph of a sample of a protective liner coating embodiment after long-term exposure to 10% and 20% phosphoric acid.

FIG. 23 is a black-and-white photograph of a sample of a protective liner coating embodiment after long-term exposure to methanol.

FIG. 24 is a black-and-white photograph of a sample of a protective liner coating embodiment after long-term exposure to 10% and 20% nitric acid.

FIG. 25 is a black-and-white photograph of a sample of a protective liner coating embodiment after long-term exposure to kerosene.

FIG. 26 is a black-and-white photograph of a sample of a protective liner coating embodiment after long-term exposure to gasoline.

FIG. 27 is a black-and-white photograph of a sample of a protective liner coating embodiment after long-term exposure to Aromatic 100.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions defined by the claims and sufficient information that would enable a person having ordinary skill in the art to make and use the inventions. In the figures, like elements may be generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details of the systems, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein may be defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in any printed publication, dictionary, or issued patent.

### 2. Certain Specific Embodiments

Now, certain specific embodiments are described, which are by no means an exclusive description of the inventions. Other specific embodiments, including those referenced in the drawings, are encompassed by this application and any patent that issues therefrom.

One or more specific embodiments disclosed herein includes a protective liner coating comprising a first solvent, wherein the first solvent comprises C9-C11 aromatic hydrocarbons; a second solvent, wherein the second solvent comprises a nature-based terpene solvent; a third solvent; an antioxidant; a first pigment, wherein the first pigment comprises an inorganic pigment; barium sulfate; a wetting agent, wherein the wetting agent comprises modified polyacrylate fluorocarbon-modified polymers; a rheological additive, wherein the rheological additive comprises attapulgite clay; a surfactant, wherein the surfactant comprises a non-reactive silicone glycol copolymer surfactant; a second pigment, wherein the second pigment comprises a liquid pigment; and a plurality of resins.

One or more specific embodiments disclosed herein includes a protective liner coating comprising a first solvent having a wt. % in the range of 10 wt. % to 15 wt. %; a second solvent having a wt. % in the range of 10 wt. % to 15 wt. %; a third solvent; an antioxidant having a wt. % in the range of 0.30 wt. % to 0.50 wt. %; a first pigment having a wt. % in the range of 10 wt. % to 15 wt. %; barium sulfate having a wt. % in the range of 10 wt. % to 15 wt. %; a wetting agent having a wt. % in the range of 0.8 wt. % to 1.0 wt. %; a rheological additive having a wt. % in the range of 0.10 wt. % to 0.20 wt. %; a surfactant having a wt. % in the range of 0.4 wt. % to 0.6 wt. %; a second pigment having a wt. % in the range of 0.10 wt. % to 0.25 wt. %; and a plurality of resins having a wt. % in the range of 24 wt. % to 28 wt. %.

One or more specific embodiments disclosed herein includes a method for making a protective liner coating comprising providing a tank and a mixer; adding a first solvent and a second solvent to the tank; mixing the first solvent and the second solvent in the tank; adding the following additional materials to the tank: an antioxidant, a first pigment, barium sulfate, a wetting agent, a rheological additive, a surfactant, and a second pigment; adding a plurality of resins to the tank; and adding a third solvent to the tank.

In any one of the coatings or methods disclosed herein, the third solvent may comprise PCBTF.

In any one of the coatings or methods disclosed herein, the antioxidant may comprise a sterically-hindered primary phenolic antioxidant stabilizer.

In any one of the coatings or methods disclosed herein, the first pigment may comprise titanium dioxide.

In any one of the coatings or methods disclosed herein, the titanium dioxide may comprise rutile titanium dioxide.

In any one of the coatings or methods disclosed herein, the barium sulfate may comprise a grade in the range of 4 to 15 microns.

In any one of the coatings or methods disclosed herein, the plurality of resins may comprise a first resin, a second resin, and a third resin.

In any one of the coatings or methods disclosed herein, the first resin may comprise a SEBS resin.

In any one of the coatings or methods disclosed herein, the second resin may comprise a hydrogenated hydrocarbon resin.

In any one of the coatings or methods disclosed herein, the third resin may comprise a hydrocarbon resin.

In any one of the coatings or methods disclosed herein, the protective liner coating may further comprise a fourth resin.

In any one of the coatings or methods disclosed herein, the fourth resin may comprise a chlorinated polyester resin.

In any one of the coatings or methods disclosed herein, the protective liner coating may further comprise a non-slip, abrasion enhancement additive.

In any one of the coatings or methods disclosed herein, the protective liner coating may further comprise strengthening fibers.

In any one of the coatings or methods disclosed herein, the additional materials added to the tank are added in the following order: the antioxidant, the first pigment, the barium sulfate, the wetting agent, the rheological additive, the surfactant, and the second pigment.

In any one of the coatings or methods disclosed herein, the method may further comprise conducting a quality control test.

In any one of the coatings or methods disclosed herein, the method of making the protective liner coating may take from 3 hours to 4 hours.

In any one of the coatings or methods disclosed herein, the plurality of resins comprises a SEBS resin, a hydrogenated hydrocarbon resin, and a hydrocarbon resin.

### 3. Specific Embodiments

The drawings presented herein are for illustrative purposes only and are not intended to limit the scope of the claims. Rather, the drawings are intended to help enable one having ordinary skill in the art to make and use the claimed inventions.

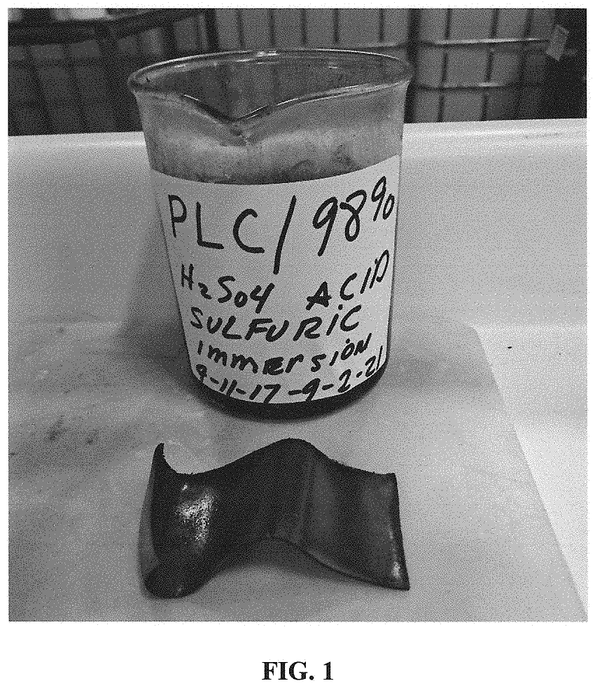

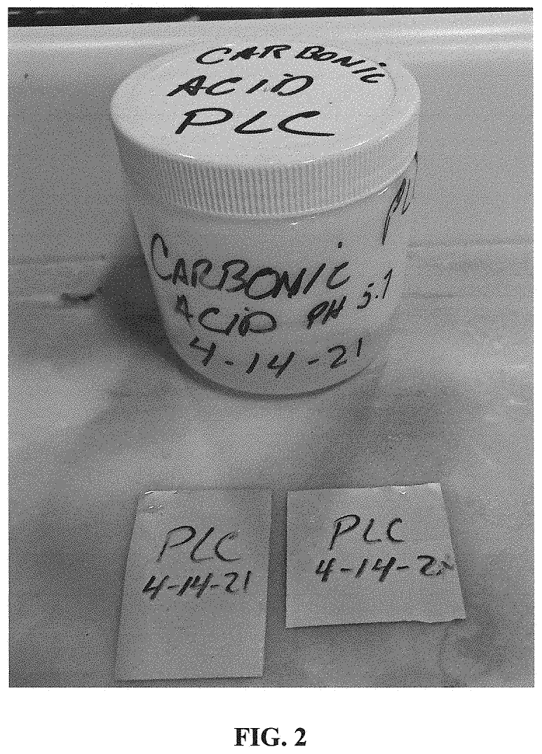

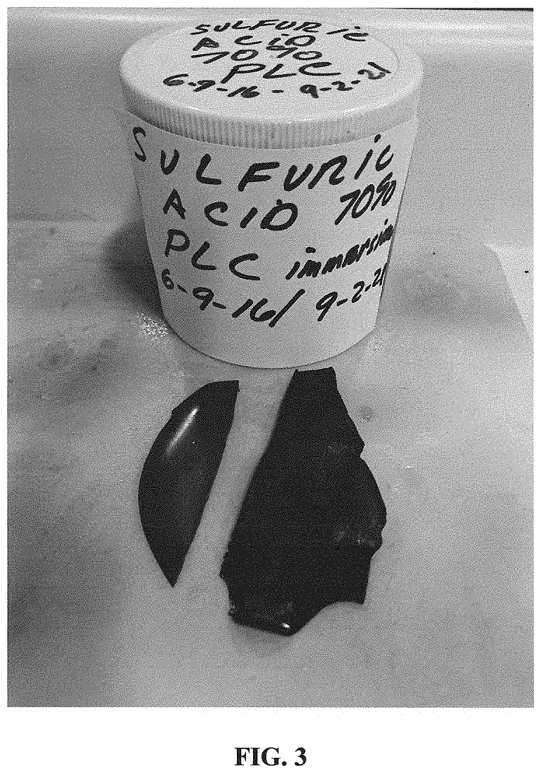

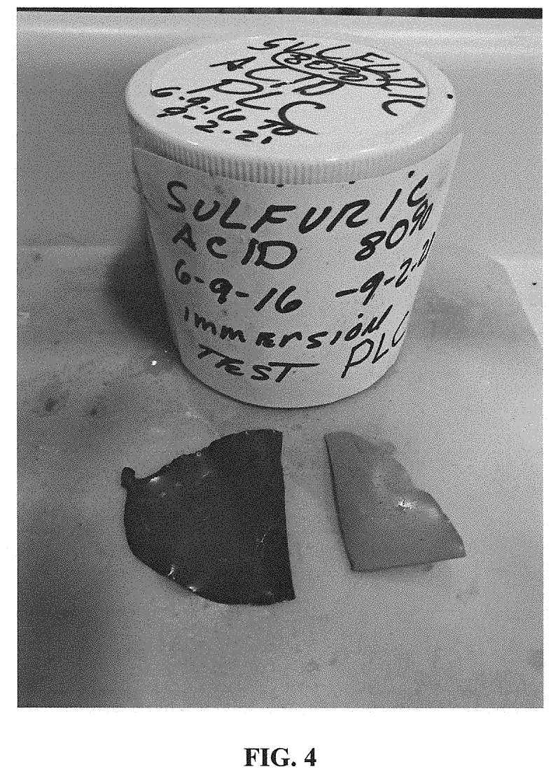

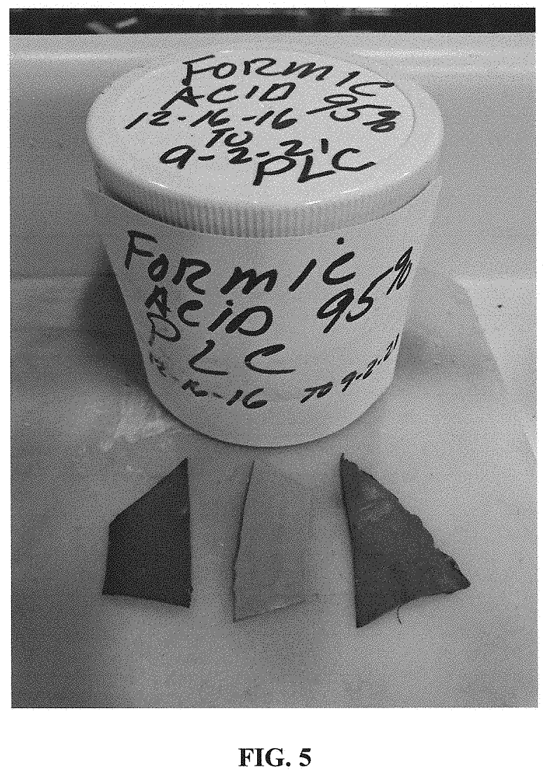

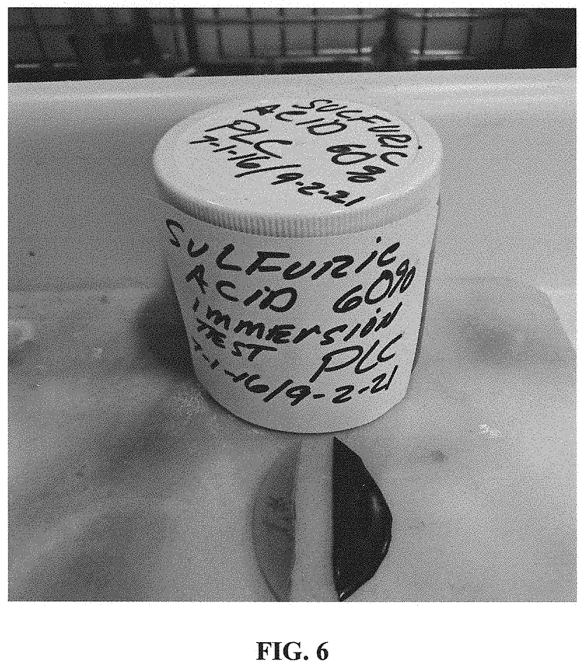

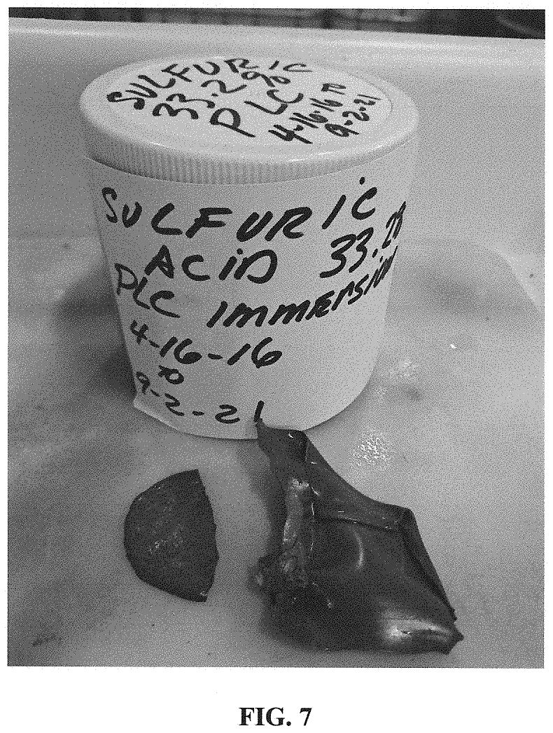

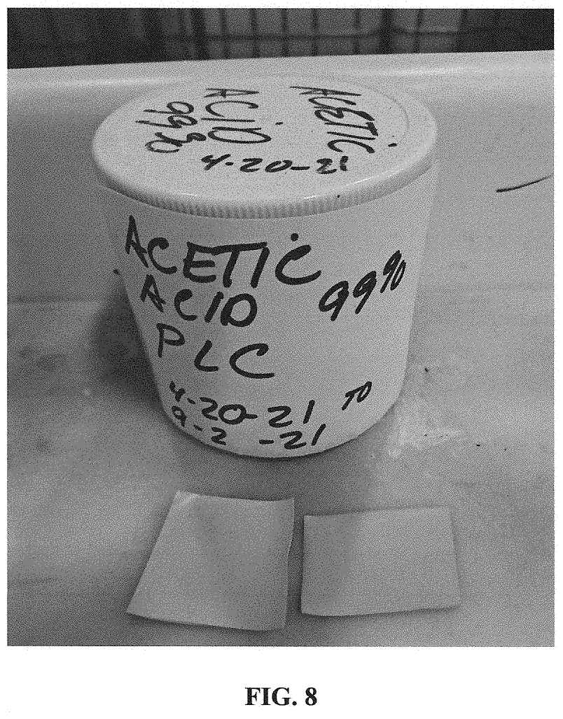

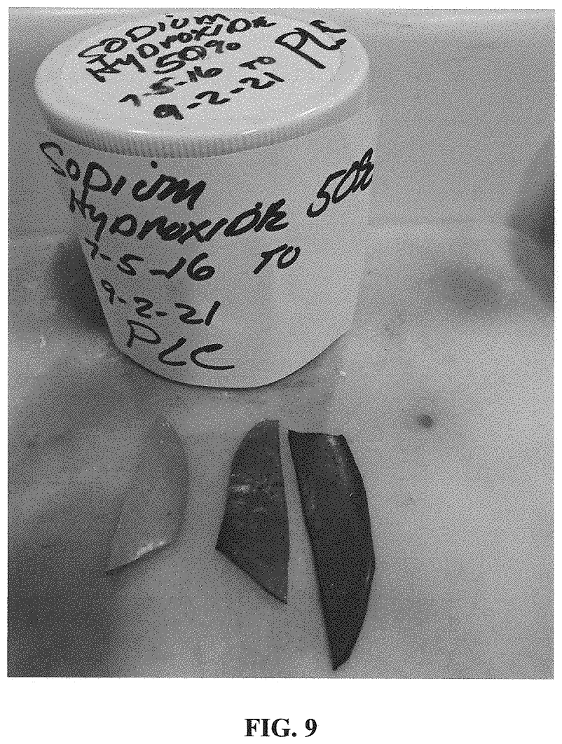

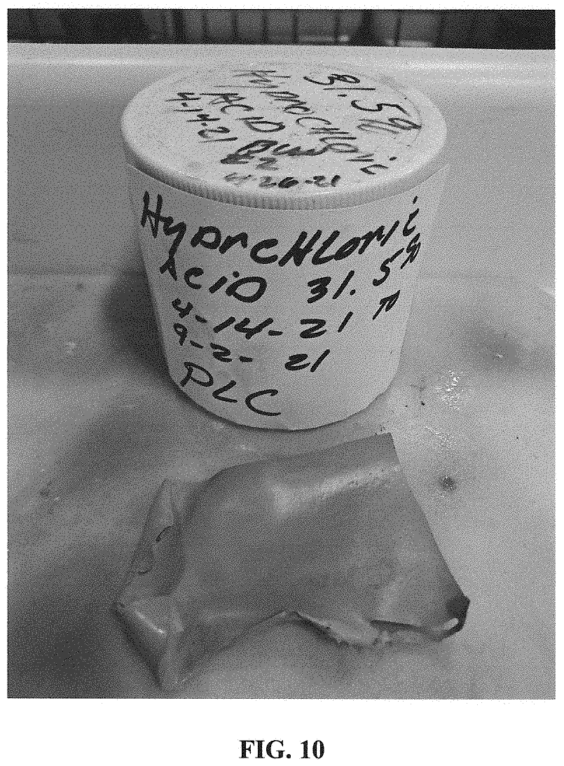

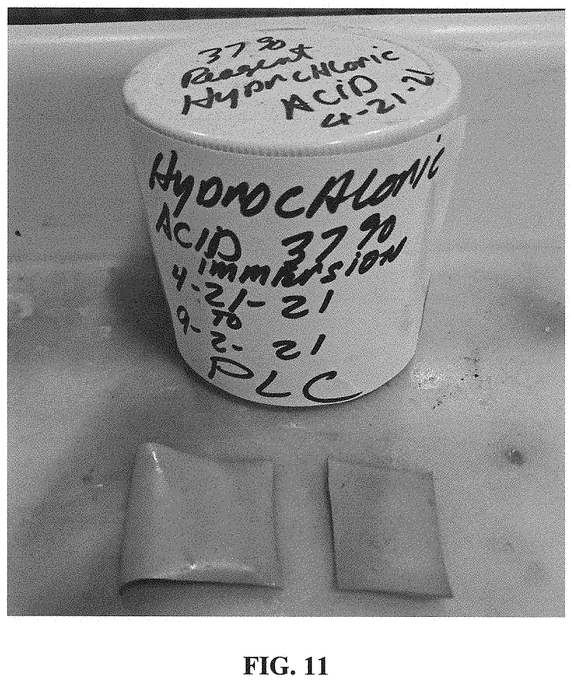

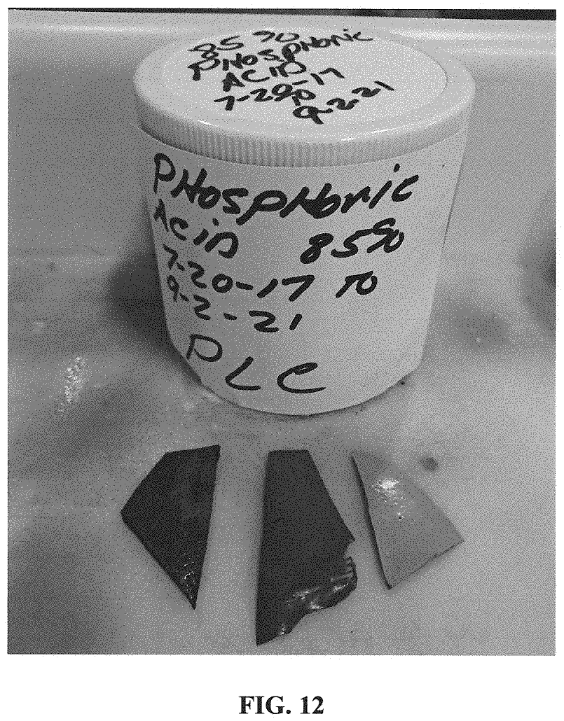

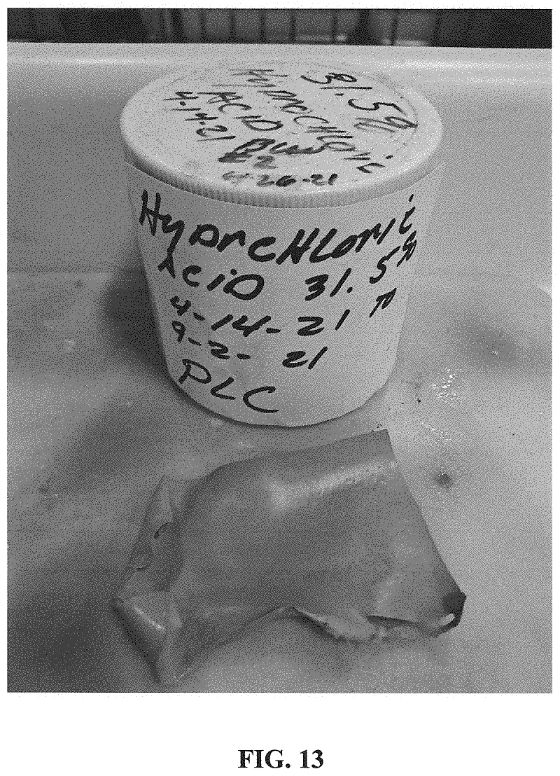

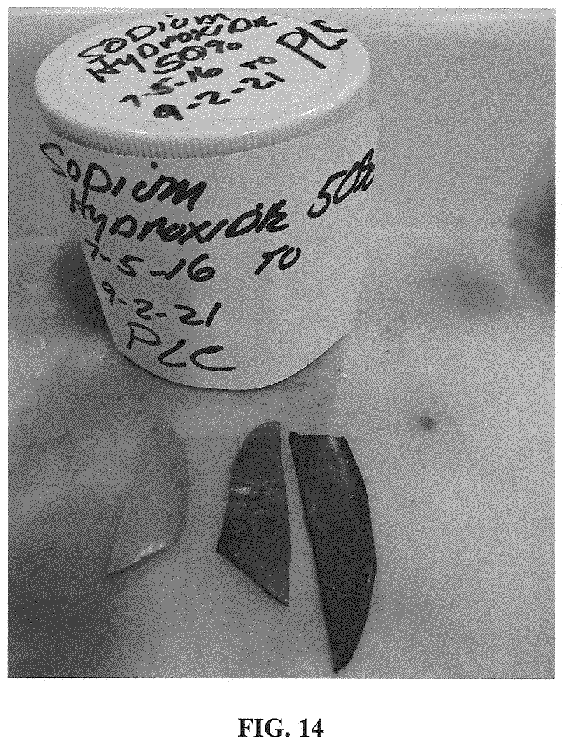

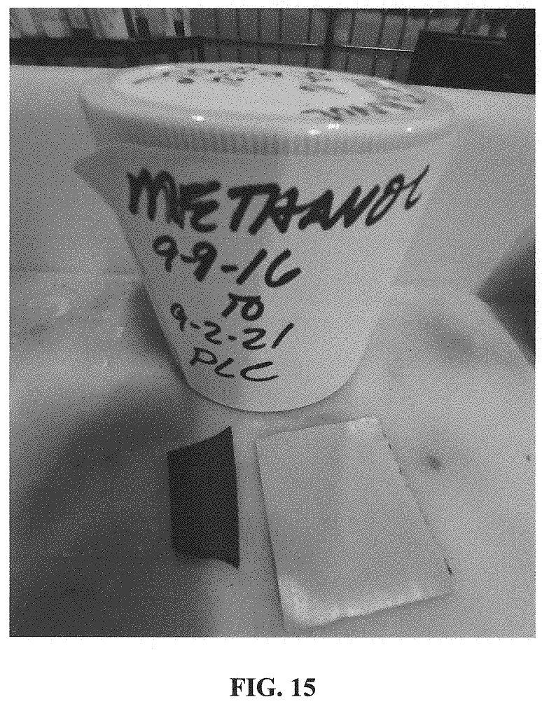

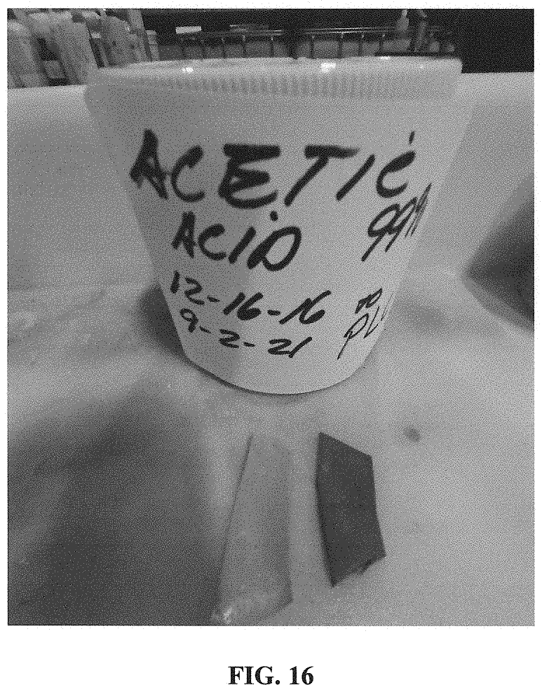

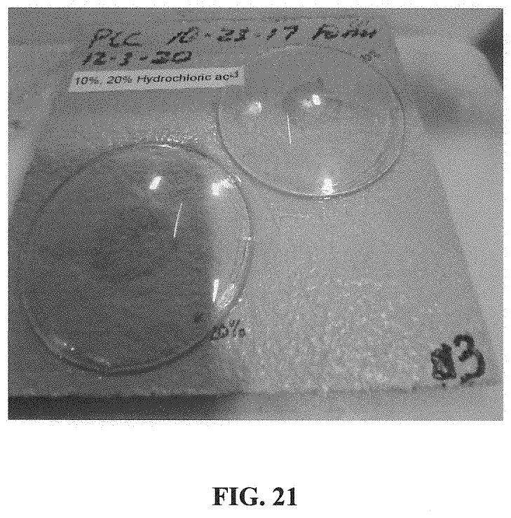

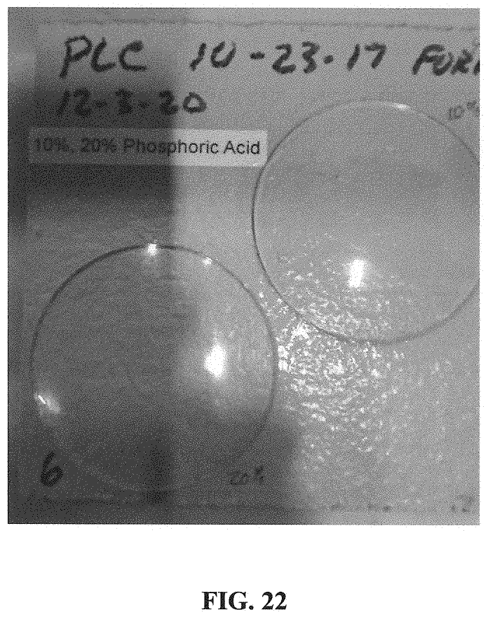

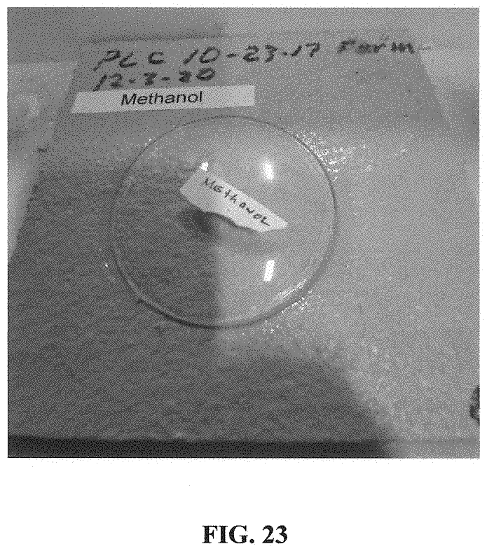

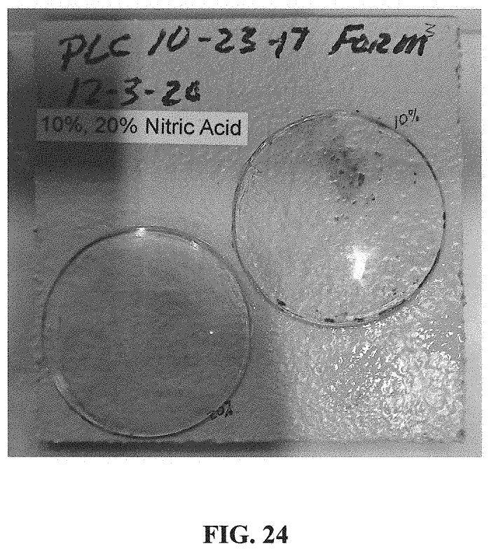

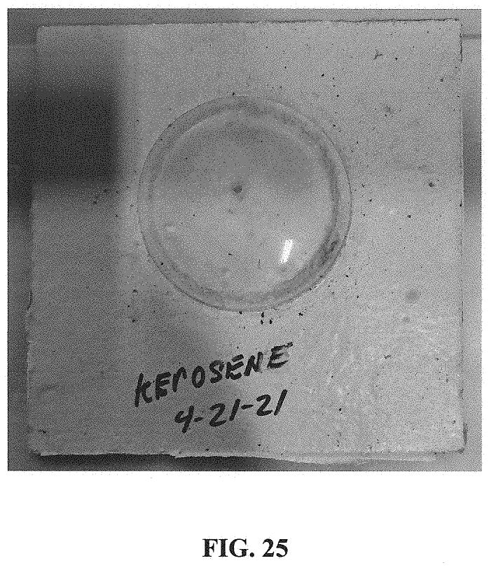

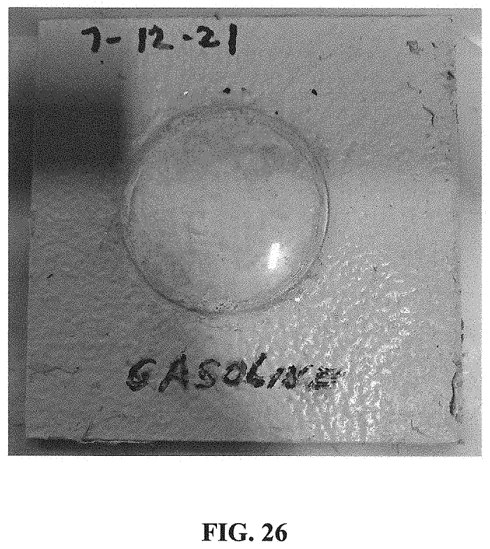

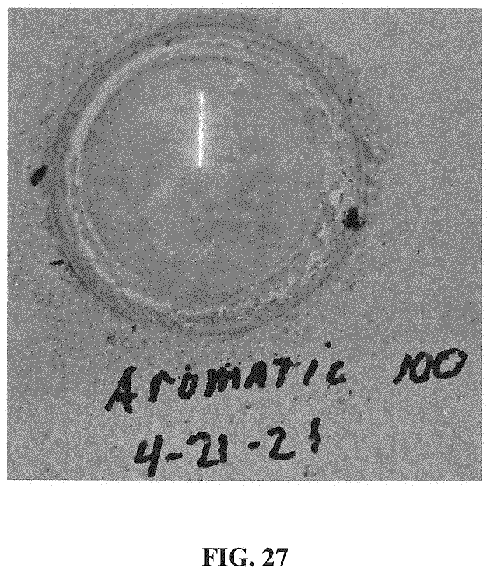

Referring to FIGS. 1-27, specific embodiments, e.g., versions or examples, of a protective liner coating are illustrated. These figures may show features which may be found in various specific embodiments, including the embodiments shown in this specification and those not shown.

The present invention relates to a protective liner coating for secondary containment protection of concrete structures from chemicals and other toxic substances. In embodiments, the protective liner coating may comprise one or more solvents, an antioxidant, a first pigment, barium sulfate, a wetting agent, a rheological additive, a surfactant, a second pigment, and one or more resins.

In embodiments, the one or more solvents may comprise a first solvent. In embodiments, the first solvent may be present in an amount of 10 wt. % to 20 wt. %, wherein the wt. % in each case is based on the total weight of the protective liner coating. Examples of the first solvent may comprise toluene (C₇H₈), Aromatic 100 (C₉H₁₂), or Aromatic 150 (C₁₀H₁₂). Aromatic 100 is comprised primarily of C9-C11 aromatic hydrocarbons. Aromatic 100 is created mainly of C9-C10 dialkyl and trialkyl benzenes, and it currently offered for sale by RB Products, Inc. Aromatic 150 may also be referred to as Aromatic Solvent C10. Aromatic 150 is primarily made up of C9-C11 aromatic hydrocarbons. Aromatic 150 is also currently offered for sale by RB Products, Inc.

In embodiments, the one or more solvents may comprise a second solvent. In embodiments, the second solvent may be present in an amount of 10 wt. % to 20 wt. %, wherein the wt. % in each case is based on the total weight of the protective liner coating. In embodiments, the second solvent may comprise a nature-based terpene solvent. An example of the second solvent may comprise Biosolv LVC #1.

In embodiments, the one or more solvents may comprise a third solvent. In embodiments, the third solvent may be present in an amount of 20 wt. % to 30 wt. %, wherein the wt. % in each case is based on the total weight of the protective liner coating. Examples of the third solvent may comprise acetone ((CH₃)₂CO) or p-chlorobenzotrifluoride (C₇H₄ClF₃), which is also referred to as PCBTF.

In embodiments, the antioxidant may be present in an amount of 0.30 wt. % to 0.50 wt. %, wherein the wt. % in each case is based on the total weight of the protective liner coating. In embodiments, the antioxidant may comprise a sterically hindered primary phenolic antioxidant stabilizer. In embodiments, the antioxidant may protect the protective liner coating from thermo-oxidative degradation. An example of the antioxidant may comprise Irganox® 1010, which is manufactured by BASF.

In embodiments, the first pigment may be present in an amount of 10 wt. % to 20 wt. %, wherein the wt. % in each case is based on the total weight of the protective liner coating. In embodiments, the first pigment may be an inorganic pigment. Further, in embodiments the first pigment may comprise rutile titanium dioxide, which may provide chalk and yellowing resistance as well as color and gloss retention. In embodiments, rutile titanium dioxide may also provide exterior durability due to its high refractive index. A high refractive index material is generally defined as a treated glass, polymer, or chemical coating possessing a refractive index greater than 1.50. In embodiments, potential brands of rutile titanium dioxide may comprise KRONOS® 2160, Huntsman Tioxide® TR-60, and/or TiONA® 696, which is sold by TRONOX.

In embodiments, the barium sulfate may be present in an amount of 10 wt. % to 20 wt. %, wherein the wt. % in each case is based on the total weight of the protective liner coating. In embodiments, the barium sulfate may be employed to increase density, increase the resistance of the coating to acids and alkalis, and contribute to higher opacity. In embodiments, the barium sulfate may comprise a grade between 4 and 15 microns. In embodiments, a potential brand of barium sulfate may be ExBar™ W400, which is manufactured by Excalibar Minerals LLC.

In embodiments, the wetting agent may be present in an amount of 0.8 wt. % and 1.0 wt. %, wherein the wt. % in each case is based on the total weight of the protective liner coating. In embodiments, the wetting agent may comprise modified polyacrylate fluorocarbon-modified polymers, which may be employed as defoamers, leveling agents, anti-cratering agents, and as an aid in substrate wetting. In embodiments, a potential brand of the wetting agent may be EKFA® FL 3277, which is manufactured by BASF.

In embodiments, the rheological additive may be present in an amount of 0.10 wt. % to 0.20 wt. %, wherein the wt. % in each case is based on the total weight of the protective liner coating. In embodiments, the rheological additive may be utilized to improve vertical sag characteristics and/or improve coating flow and in-can stability. In embodiments, the rheological additive may comprise bentonite or other rheological modifiers available to the formulator. In embodiments, the rheological additive may comprise attapulgite clay. In embodiments, a potential brand of the rheological additive may be Bentone SD®-1, which is manufactured by Elementis.

In embodiments, the surfactant may be present in an amount of 0.4 wt. % to 0.6 wt. %, wherein the wt. % in each case is based on the total weight of the protective liner coating. In embodiments, the surfactant may comprise a non-reactive silicone glycol copolymer surfactant, which may provide slip, gloss enhancement, pigment treatment, and leveling. In embodiments, the surfactant may also provide mar resistance. In embodiments, a potential brand of the surfactant is Dow Corning® 57 Additive.

In embodiments, the second pigment may be present in an amount of 0.10 wt. % to 0.25 wt. %, wherein the wt. % in each case is based on the total weight of the protective liner coating. In embodiments, the second pigment may comprise liquid or powdered colorizing pigments, depending on the customer's preference. In one embodiment, liquid lamp black, such as PureOptions® B, which is manufactured by BASF, may be utilized. In embodiments, the second pigment may comprise carbon black, barium sulphate, talc, and/or quartz. In other embodiments, the second pigment may comprise powdered pigments, such as Aditya Birla's carbon black and/or numerous other colorants.

In embodiments, the one or more resins may comprise a first resin. In embodiments, the first resin may comprise synthetic rubbers, which may comprise a wide variety of styrene/rubber ratios. For example, in one embodiment the first resin may be present in an amount of 10 wt. % to 15 wt. %, wherein the wt. % in each case is based on the total weight of the protective liner coating. In embodiments, the first resin may comprise one SEBS resin (defined as a thermoplastic elastomer with styrene added), which may be introduced to the formulation for the coating in order to lower elongation to about 150%. In another embodiment, the first resin may comprise a different SEBS resin, which may be introduced to the formulation for the coating in order to achieve a higher elongation to roughly 450%. In embodiments, the source of the first resin may be a wide variety of both domestic and offshore manufacturers. In other embodiments, the first resin may comprise styrene-isoprene-styrene (SIS) resins, styrene-butadiene-styrene (SBS) resins, or styrene-isoprene-butadiene-styrene (SIBS) resins. In embodiments, the first resin may comprise KRATON™ FG1901 G Polymer.

In embodiments, the one or more resins may comprise a second resin. In embodiments, the second resin may be combined with the first resin. In embodiments, the second resin may comprise hydrogenated hydrocarbon resins having a ring and ball softening point of 130° C. (266° F.) and acting as tackifier reinforcement resins. In embodiments, hydrogenated resins may provide improved color and thermal stability. Further, in embodiments, the second resin may comprise either a C-5 aromatic resin with 5 carbon atoms or a hydrogenated C-9 aromatic resin with 9 carbon atoms. In embodiments, the second resin may comprise either aliphatic or aromatic polymers of monomers. Additionally, in embodiments the second resin may be present in an amount of 10 wt. % to 15 wt. %, wherein the wt. % in each case is based on the total weight of the protective liner coating. There may be a wide variety of manufacturers and distributors, both domestic and offshore, for the second resin. In embodiments, the second resin may comprise Eastotac™ H-130W Resin, which is manufactured by Eastman.

In embodiments, the one or more resins may comprise a third resin. In embodiments, the third resin may comprise a lower molecular weight, resulting in a higher softening point of the resin, which may be produced by co-polymerization of pure aromatic hydrocarbon monomers, and further, may typically provide increased heat stability, resistance to long-term solar UVA oxidation, and resistance to discoloration. In embodiments, the third resin may be present in an amount of 4 wt. % to 7 wt. %, wherein the wt. % in each case is based on the total weight of the protective liner coating. Further, in embodiments the third resin may comprise either a C-5 aliphatic or hydrogenated monomer and/or C-9 aromatic resin, which may be utilized either as pure monomers or hydrogenated C-9 aromatic monomer resins. In embodiments, the third resin may comprise Kristalex™ 5140, which is manufactured by Eastman.

Additionally, in embodiments the one or more resins may further comprise a fourth resin. In embodiments, the fourth resin may comprise a chlorinated polyester resin, which may provide resistance against various chemicals. In embodiments, the fourth resin may be present in an amount of 10 wt. % to 15 wt. %, wherein the wt. % in each case is based on the total weight of the protective liner coating.

Additionally, in embodiments non-slip/abrasion enhancement additives may be utilized as part of the formulation of the protective liner coating. In embodiments, these non-slip/abrasion enhancement additives may be nature-based and/or man-made. Examples of such additives may be quartz sand, silica sand, polypropylene and other plastic media, glass spheres, alumina/aluminum oxide or other similar aggregates, and ground nut shells, such as, but not limited to, walnut shells.

Further, in embodiments coating film strengthening fibers may also be utilized as part of the formulation of the protective liner coating. In embodiments, ultra high-strength fibers such as, but not limited to, Roy-Tuff™ 9021, which is manufactured by H.M. Royal, and DuPont Kevlar® fibers and/or other ballistic type fibers may be mixed into the coating during a final mix cycle, which may improve abrasion and resistance to hot-tire turning and sharp object damage. In embodiments, the fibers may be present in an amount of 1.0 wt. % to 3.0 wt. %, wherein the wt. % in each case is based on the total weight of the protective liner coating.

Regarding the method of manufacturing the protective liner coating, in embodiments that method may begin with providing a mixing tank and a high-speed disperser blade. In embodiments, the appropriate mixing tank and high-speed disperser blade may depend on various factors such as the amount of the materials being mixed and viscosity. Generally, this is standard industrial equipment with several options, and a person of ordinary skill in the art would be familiar with these options. Further, even small adjustments in the diameter of the disperser blade or the RPM may dramatically increase the required power for mixing.

In embodiments, the next step of the method may be for the first solvent and the second solvent to be added to the tank. In embodiments, the mixer may then be started at a slower speed setting, and the following materials may be added in the following order: the antioxidant, the first pigment, the barium sulfate, the wetting agent, the rheological additive, the surfactant, and the second pigment. In embodiments, the mixing time for the addition of the antioxidant, the first pigment, the barium sulfate, the wetting agent, the rheological additive, the surfactant, and the second pigment may vary by batch size. In some embodiments, this mixing time may be 10 to 20 minutes depending on the batch size. In embodiments, once the antioxidant, the first pigment, the barium sulfate, the wetting agent, the rheological additive, the surfactant, and the second pigment have been added to the mixer, the speed of the mixer may be increased to a higher speed for about 20 minutes. Afterwards, in embodiments the mixer speed may be reduced for the addition of the remaining materials as discussed in the following paragraphs.

Following the reduction of the speed of the mixer, in embodiments the following resins may be added slowly in the following order: the first resin, the second resin, and the third resin. In embodiments, once the first resin, the second resin, and the third resin have been added to the mixer, the speed of the mixer may be increased (or maintained) until the first resin, the second resin, and the third resin are completely incorporated (dissolved) in the mixture. During this mixing, in embodiments the viscosity of the mixture may increase. In embodiments, the third solvent may be added to the mixture at that time in order to keep the mixture fluid. In embodiments, the mixer may then continue operating for about two hours.

After the mixing described above is completed, in embodiments a quality control test may be performed on a sample of the mixture of the protective liner coating. In embodiments, the overall process of mixing a batch of the protective liner coating may take anywhere from 3 to 4 hours depending on the batch size.

In embodiments, the protective liner coating may be employed as a chemical-resistant coating for concrete in retention areas where spills may damage concrete. In embodiments, the protective liner coating may be a flexible, single-package coating that resists acids, alkalis, solvents, and a wide variety of other chemicals.

In embodiments, application of the protective liner coating may be broken down into two stages: preparation and actual application. With regard to preparation, in embodiments new concrete may be allowed to cure for a minimum of 30 days to allow moisture to equilibrate. In embodiments, power washing the concrete to remove any efflorescence may be recommended. Further, in embodiments the concrete may be allowed to dry thoroughly prior to application of the protective liner coating. In embodiments, older concrete must be free from surface contamination and other imperfections. In embodiments, prior coatings may be left in place if they are properly adhered to the concrete. Also, in embodiments an adhesion test may be performed to confirm that the protective liner coating will adhere to any previous coating on the concrete. In embodiments, light abrasion of the surface of the concrete may be needed to increase adhesion to the concrete. In embodiments, all degraded substrates may be repaired or replaced prior to the application of the protective liner coating.

With regard to actually applying the protective liner coating, in embodiments the coating should not be applied at temperatures below 10° C. (50° F.) or during adverse weather conditions. Further, in embodiments, given that the coating is solvent borne, the usual safety precautions known to one of ordinary skill in the art should be observed to protect the coating from heat, sparks, and open flames during application of the coating. In embodiments, the coating should be thoroughly stirred prior to application. For example, in embodiments 1-2 minutes of stirring using a power drill should be sufficient. In one embodiment, the coating may be applied by spraying the coating on the concrete. In embodiments, the spraying made be done using an airless spray. In embodiments, the user may adjust pressure for proper fan and to minimize any fingering. In embodiments, it may be recommended that the user employ the minimum pressure possible. Further, in embodiments the user may apply the coating to a depth of 20 mils (0.508 mm) wet and allow the coating to dry. In embodiments, two coats of coating may be required to prevent any voids or to ensure that enough of the protective liner coating is applied.

In other embodiments, other application techniques may be employed such as application by brush, roller, or notched squeegee. Once again, in embodiments the user may apply the coating to a depth of 20 mils (0.508 mm) wet and allow the coating to dry. In embodiments, two coats of coating may be required to prevent holidays. In embodiments, the user may also wear spike shoes during application.

In embodiments, surfaces such as concrete may be prepared according to SSPC-SP 10 (NACE No. 2, Sa 2.5), which will be known to those of ordinary skill in the art. In embodiments, application of the protective liner coating may require only simple tools. For example, in embodiments the coating may be applied by pouring the coating from a bucket onto surface-treated concrete, by long-handled squeegee, which may be preferable, by spraying, or by brushing. One of the benefits of the embodiments of the coating disclosed herein is the lack of pot life restrictions. For example, in embodiments a can of coating may be opened and stirred for 1 to 2 minutes before applying the coating.

Once again, one of the advantages of the protective liner coating is the vastly higher elongation (30 to 40 times higher) than competitors such as Novolacs and vinyl esters. In embodiments, the protective liner coating may be employed to create an impermeable membrane resistant to chemicals, water/sea water, and UVA rays due to the ability of the coating to bridge any concrete surface cracks because of the elongation capabilities of the coating, which may prevent chemicals or other harmful substances from permeating into the ground underneath the concrete.

The following paragraphs discuss various tests performed on embodiments of the protective liner coating. For purposes of these tests, the following ingredients were employed in the percentage range amounts stated in the following Table 1. This formulation will be referred to in the following paragraphs as “the test coating.”

TABLE 1

| | | % Total Weight of | |
|---|---|---|---|
| No. | Ingredient | the Test Coating | |
| 1. | Aromatic Hydrocarbon | 10-13 | wt. % |
| 2. | Nature-Based Terpene Solvent | 10-13 | wt. % |
| 3. | Sterically-Hindered Primary | 0.10-0.60 | wt. % |
| | Phenolic Antioxidant | | |
| 4. | Rutile Titanium Dioxide | 9-12 | wt. % |
| 5. | Barium Sulfate | 9-12 | wt % |
| 6. | Modified Polyacrylate Fluorocarbon- | 0.4-1 | wt. % |
| | Modified Polymers | | |
| 7. | Attapulgite Clay | 0.10-0.50 | wt. % |
| 8. | Non-Reactive Silicone Glycol | 0.20-0.70 | wt % |
| | Copolymer Surfactant | | |
| 9. | Liquid Pigment | 0.10-0.50 | wt. % |
| 10. | SEBS Resin | 10-13 | wt. % |
| 11. | Hydrogenated Hydrocarbon Resin | 9-12 | wt. % |
| 12. | Hydrocarbon Resin with low | 3-6 | wt. % |
| | molecular weight | | |
| 13. | PCBTF | 25-30 | wt. % |

### Physical Properties Tests

In order to test the elongation and other physical properties necessary for commercial and industrial use, the test coating was used for physical properties testing. The test method used was ASTM D638-14, which will be known to a person of ordinary skill in the art. In preparation for the physical properties testing, the test coating was sprayed on a PTFE substrate in order to create films. More specifically, dog bone test coupons were prepared using the spray-on method, and the coupons were allowed to cure for 5 days. Then, the test panels were peeled off of the PTFE substrate, which was followed by cutting the panels into specimens comprising the following dimensions: 0.5117 inches (13 mm) wide by 0.0185 inches (0.47 mm) thick by 2.0 inches (50.8 mm) long.

One of the physical property tests performed was for tensile properties of the specimen of the test coating. The test method employed an Instron Model #3369 with BlueHill-II Software, a test temperature of 25° C. (77° F.), a crosshead speed of 5 inches(127 mm)/min, a gage length of 4.5 inches (114.3 mm), and a sample size of ASTM D638 Type 1 Dogbone. Each specimen was broken down into three samples as shown in the following Table 2:

TABLE 2

Tensile Sample Size

| Sample # | Width, Inch/mm | Thickness, Inch/mm |
|---|---|---|
| 1-1 | 0.520/13.208 | 0.125/3.175 |
| 1-2 | 0.524/13.310 | 0.112/2.845 |
| 1-3 | 0.524/13.310 | 0.100/2.54 |
| 2-1 | 0.512/13.005 | 0.120/3.048 |
| 2-2 | 0.525/13.335 | 0.115/2.921 |
| 2-3 | 0.524/13.310 | 0.113/2.870 |
| 3-1 | 0.517/13.132 | 0.223/5.664 |
| 3-2 | 0.524/13.310 | 0.207/5.258 |
| 3-3 | 0.515/13.081 | 0.220/5.588 |
| 4-1 | 0.530/13.462 | 0.045/1.143 |
| 4-2 | 0.526/13.360 | 0.045/1.143 |
| 4-3 | 0.527/13.386 | 0.041/1.041 |

The results of the testing are shown in the following table:

TABLE 3

| | Secant | Tensile | Elongation | Ultimate | |
|---|---|---|---|---|---|
| Sample | Modulus | Strength to | to | Tensile | Strain at |
| # | @10%, PSI | Break, PSI | Break % | Strength, PSI | UTS, % |
| 1-1 | 460 | 239 | 221 | 253 | 189 |
| 1-2 | 473 | 273 | 191 | 277 | 180 |
| 1-3 | 538 | 302 | 214 | 327 | 203 |
| 2-1 | 775 | 456 | 197 | 492 | 185 |
| 2-2 | 824 | 429 | 153 | 477 | 143 |
| 2-3 | 813 | 464 | 173 | 489 | 164 |
| 3-1 | 600 | 260 | 120 | 308 | 101 |
| 3-2 | 637 | 305 | 112 | 331 | 103 |

The results of the tensile tests illustrates that the test coating possesses 20 to 60 times higher elongation to conform to cracking concrete than any materials currently on the market. This bridging characteristic of the protective liner coating is a significant advantage of using embodiments of the protective liner coating. In other words, the protective liner coating will not crack as the concrete does so, which tends to form a bridging membrane that prevents adverse chemical intrusion into the ground.

### Immersion Chemical Resistance Test

Another test that was performed on the test coating was an immersion chemical resistance test. In this test, the chemical resistance properties of the test coating were evaluated to determine whether the coating may protect concrete from chemical destruction.

For purposes of this test, each panel had the test coating spray-applied to it using an HVLP spray gun to an approximate wet film thickness of 60-80 mils (1.524 mm-2.032 mm). For this test a Binks 5-gallon, galvanized ASME code pressure tank with bottom outlet, dual regulators, and agitators with a 15-foot by ⅜-inch fluid hose and 15-foot by 5/16-inch atomizing air hose. The needle nozzle size set up was 66, 67, or 68 depending on coating thickness. The samples of the test coating were allowed to cure for approximately 5 days. It was ascertained that the most severe test would be to cut strips of free-film test coating into samples and subject the test coatings to complete immersion for long periods of time. The complete surrounding and total immersion of the test coating in a chemical bath would subject the test coating's chemistry to an accelerated worst-case scenario. Therefore, small strips of the test coating were cut and immersed into pint-size HDPE jars. These jars contained various strong and mild acids, caustics, and other chemicals, which were then placed in an array and observed routinely over many months—and then over several years. More specifically, the panels were exposed to the following materials: sulfuric acid, formic acid, acetic acid, nitric acid, hydrochloric acid, phosphoric acid, sodium hydroxide, methanol, and concentrated salt brine (˜20%). Each sample was exposed for a period of time as indicated in the following table:

TABLE 4

| Material | Duration of Exposure | | Associated FIG. |
|---|---|---|---|
| 98% Sulfuric Acid | 1,451 | days | 1 |
| pH 5.7 Carbonic Acid | 146 | days | 2 |
| 70% Sulfuric Acid | 1,915 | days | 3 |
| 80% Sulfuric Acid | 1,915 | days | 4 |
| 95% Formic Acid | 1,737 | days | 5 |
| 60% Sulfuric Acid | 1,953 | days | 6 |
| 33.2% Sulfuric Acid | 1,952 | days | 7 |
| 99% Acetic Acid | 139 | days | 8 |
| 50% Sodium Hydroxide | 1,889 | days | 9 |
| 31.5% Hydrochloric Acid | 145 | days | 10 |
| 37% Hydrochloric Acid | 138 | days | 11 |
| 85% Phosphoric Acid | 1,509 | days | 12 |
| 31.5% Hydrochloric Acid | 145 | days | 13 |
| 50% Sodium Hydroxide | 1,859 | days | 14 |
| Methanol | 1,825 | days | 15 |
| 99% Acetic Acid | 1,728 | days | 16 |

At the end of each time period identified in Table 4, each sample of the test coating was inspected for any visual degradation and checked for cleaving of the linkage of hydrogen bonds and other forms of chemical-induced polymer-bond dissociation. The test coating offered great resistance to the materials identified in Table 4. Each of the samples showed little to no degradation during the entire test procedure. FIGS. 1-16 are photographs taken of the samples of test coatings at the end of each testing period, as further explained in Table 4.

### Concrete Adhesion Test

Another test performed on the test coating was the concrete adhesion test, which was conducted to obtain adhesion data for the formulated coating on concrete. Previous to this test, the test coating had generally displayed good adhesion characteristics in the many tests previously performed. However, this test was conducted to accurately quantify the test coating's true adhesion substrate-bonding performance to evaluate possible use on concrete road surfaces, highway infrastructure, buildings, and a myriad of other scenarios where concrete is required for long-term protection from the elements, industrial chemicals, road salt, and countless other issues.

The test equipment used was a PosiTest Pull-Off Adhesion Tester AT-M (Manual) V.4.0. using ASTM 4541 as the standard. The test preparation procedure comprised the following: Step 1, the dolly (pull stub) and the concrete substrate to be coated with the test coating were cleaned and abraded; Step 2, an epoxy adhesive was prepared and applied to the dolly, and the dolly was then adhered to the coated surface and the adhesive allowed to cure; Step 3, the test area of the test coating was precut around the dolly using an X-Acto type knife; Step 4, the PosiTest AT-M pull off adhesion tester was attached to each dolly; and Step 5, the test results were analyzed. The dolly and the test coating were examined and evaluated to determine the nature of the coating failure, if any.

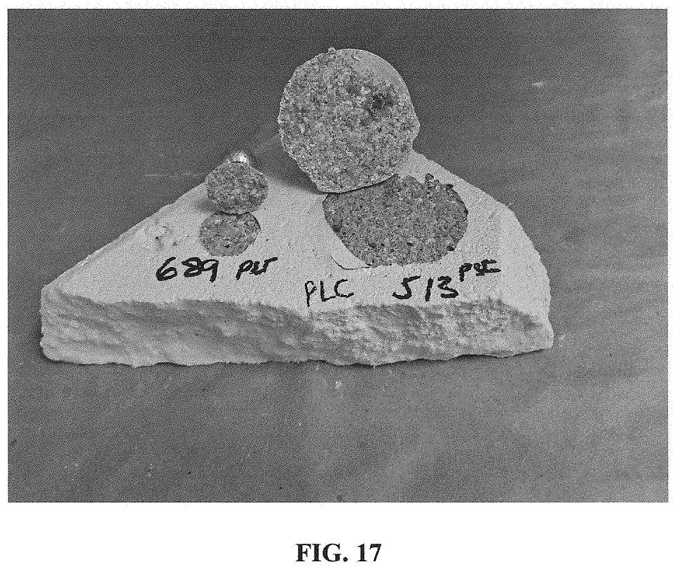

In summary, one 20 mm dolly and one 50 mm dolly were attached to the coated concrete with epoxy adhesive and allowed to cure for 24 hours. The 20 mm dolly test achieved 689 PSI, and the 50 mm dolly achieved 513 PSI. Note that the concrete was a precast section of a 3000 PSI concrete paver pad obtained at Home Depot. FIG. 17 is a photograph of the coated concrete taken after the test was conducted.

Based on the results of this test, the test coating offers exceptional adhesion characteristics on concrete substrates. This is significant because the concrete substrate failed before the test coating failed.

### Moisture Vapor Transmission Test

A further test applied to the test coating was the moisture vapor transmission test, which was conducted to obtain general test data. More specifically, this test was performed to test the test coating's resistance to vapor permeability and condensates. The test was performed according to ASTM D1653-13, the standard method for water vapor transmission of organic coating films.

The test method employed was the Wet (Payne) Cup Method. A standard 25 mm Gardco wet-cup sample was sealed to the open mouth of a cup or dish containing water. The exterior relative humidity (within the chamber) was 30%. The relative humidity (within the cup) was 99%. In this test, the “tester weight empty” is the control and the “tester weight loaded” is the panel once immersed. Further, the “mil” figures indicate the overall thickness of the coating, and the numbers in the table for each “chk” provides information on the weight gain (in pounds) of the sample during the immersion of the sample, which provides information on how much the coated sample as absorbed. The following table shows the test results:

TABLE 5

| | Tester | Tester | chk 1 | chk 2 | chk 3 | chk 4 | chk 5 |
|---|---|---|---|---|---|---|---|
| | weight | weight | Nov. 13, | Nov. 14, | Nov. 15, | Nov. 16, | Nov. 17, |
| | empty | loaded | 2017 | 2017 | 2017 | 2017 | 2017 |
| Tester 1 | | | | | | | |
| Tester 3 | 134.0617 | 147.3545 | 147.3545 | 147.2482 | 147.2211 | 147.1931 | 147.1678 |
| 21 mil | | | 0.0780 | 0.1063 | 0.0271 | 0.0280 | 0.0253 |
| Average | | | | | | | |
| Tester 4 | 134.1115 | 147.0175 | 146.9771 | 146.963 | 146.9483 | 146.9333 | 146.9215 |
| 19 mil | | | 0.0404 | 0.0141 | 0.0147 | 0.0150 | 0.0118 |
| Average | | | | | | | |
| Tester 5 | 134.3759 | 147.3514 | 147.2501 | 147.2152 | 147.1768 | 147.1379 | 147.1043 |
| 19 mil | | | 0.1013 | 0.0349 | 0.0384 | 0.0389 | 0.0336 |
| Average | | | | | | | |
| | Tester | Tester | chk 6 | chk 7 | chk 8 | chk 9 | chk 10 |
| | weight | weight | Nov. 20, | Nov. 22, | Nov. 27, | Nov. 28, | Nov. 29, |
| | empty | loaded | 2017 | 2017 | 2017 | 2017 | 2017 |
| Tester 1 | | | | | | | |
| Tester 3 | 134.0617 | 147.3545 | 147.0876 | 147.0466 | 146.924 | 146.9023 | 146.8771 |
| 21 mil | | | 0.0802 | 0.0410 | 0.1226 | 0.0217 | 0.0252 |
| Average | | | | | | | |
| Tester 4 | 134.1115 | 147.0175 | 146.881 | 146.8605 | 146.8022 | 146.7922 | 146.7805 |
| 19 mil | | | 0.0405 | 0.0205 | 0.0583 | 0.0100 | 0.0117 |
| Average | | | | | | | |
| Tester 5 | 134.3759 | 147.3514 | 146.9908 | 146.9329 | 146.7594 | 146.7283 | 146.6928 |
| 19 mil | | | 0.1135 | 0.0579 | 0.1735 | 0.0311 | 0.0355 |
| Average | | | | | | | |

Generally, water vapors will tend to migrate from regions of relatively high absolute humidity to regions of low absolute humidity, thus negatively affecting the integrity of the original substrate. The test coating demonstrated exceptional resistance to permeability.

### UV Outdoor Exposure Test

Another test on the test coating was the UV outdoor exposure chemical resistance test, which was conducted to determine the UVA, UVB, and inclement weather resistance of the test coating.

Generally, the test coating had displayed continuous polymer cross-linking integrity while displaying UVA and UVB resistance. It should be understood that UVA rays are 500 times more damaging and penetrative than UVB rays. Concrete can be severely damaged by solar-derived UV rays. For example, direct sunlight causes water to evaporate from newly poured concrete prematurely. Further, UV radiation breaks down the polymers and other bond chains of even cured concrete. Other times, UV damage weakens the concrete, turns it to a fine dust, and causes cracking and spalling away from joints and seams. The formulated coating had been shown to be impervious to even long-term solar radiation and toxic chemicals.

For this test, each test panel had the test coating spray-applied using an HVLP spray gun to an approximate wet film thickness of 60-80 mils (1.524 mm-2.032 mm). Each 12-inch x 12-inch x 12-inch 3000 PSI test concrete panel was surface prepared by following NACE #6 SSPC-SP 13 (following a 28 day waiting period). It should also be noted that concrete surfaces will have substantially fewer pin holes if the application is done as the ambient temperature is descending (after noon) rather than in ascending temperatures (in the morning). Surface preparation of test concrete substrate varies with a number of options. Contractors can consider the following options for cementitious surface preparation methods: Dry Abrasive Blasting, West Abrasive Blasting, High-Pressure Water Cleaning, Impact Tools, Power Tools, Flame Blasting, and Acid Etching.

Each test panel was prepared by dry abrasive blasting. The test coating was first brushed onto the surfaces of the test panels using commercial paint brushes. In addition, rollers, spray coating, or simply pouring the coating contents onto the prepared surface, using long handled rubber squeegees, can also be done.

A test coating primer was made at the testing sight by simply mixing a bucket half full of the test coating with an equal amount of an exempt solvent, such as PCBTF. The primer mixture was mixed with a commercially available Jiffy mixer, but other types of mixers may be used to mix coatings. The primer mixture was mixed for two minutes, and then applied to the panels at a thickness of approximately 5 to 7 mils (0.127 mm to 0.178 mm) wet. The application was allowed to dry for two hours, and then the test coating was applied with at least two coats of 30 mils (0.762 mm) each, wet. Each panel was then placed outdoors, set to be exposed to the sun, rain, and inclement weather. The panels were left continuously exposed to inclement weather, including temperatures exceeding 105° F. in the summers, flooding during Hurricane Harvey, and an arctic freeze—as well as many countless drenching downpours, followed by radiant sunlight exposure.

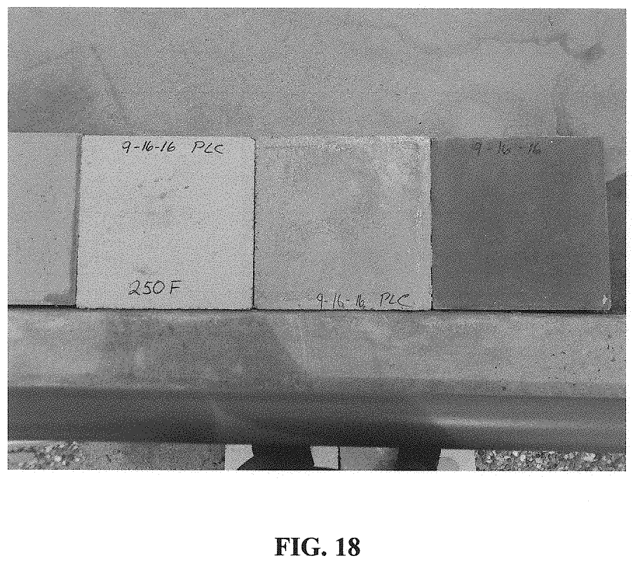

FIG. 18 is a photograph of concrete panels coated with the test coating, which shows the effects of five years of outdoor exposure. The results of this test showed that the test coating showed slight weathering and fading due to UVA radiation over a 5-year period. However, the test coating still retained its elasticity and polymeric cohesive chain bonds. The test coating showed great resistance to the wide range of weather exposure as discussed above. The samples showed little to no degradation during the entire test procedure.

### QUV Accelerated Weathering Test

Another test the test coating was subjected to was the QUV accelerated weathering test via ASTM-D1653-13. Essentially, this was another test to evaluate the resistance of the test coating to UVA radiation.

As part of this test, each test panel was created using the applicant's “Draw Down” method, where a 3-inch×6-inch×0.025 inch 3003-H14 mill finished aluminum Q-panel test coupon, obtained from its supplier Q-Lab Corporation, was placed on a plate glass fixture, and then a draw down bar (set at 50 mils wet) was placed on top of the test coupon.

Next, the formulated coating was poured onto the front portion of the draw down bar. The lab technician then pulled the draw down bar smoothly across the length of the Q-panel creating an approximate 50 mil wet thickness (35 mils dry). The coated Q-Panel test coupon was then allowed to dry at an ambient temperature ranging from 68° F. to 72° F. for five days. Each 3-inch×6-inch×0.025-inch Q-Panel was then attached to an aluminum holding fixture and placed at a slight angle inside the QUV Weathering Chamber, where it underwent a 6-hour cycle of exposure to UVA radiation, set at a fixed 0.89 W/mK (340 nm) irradiance within a wet environment, followed by a 6-hour cycle of drying. This cycle was continuously repeated.

This wet/dry cycling test involved a number of 30 mil (dry) coated panels secured within the mounting fixtures. Two test fixtures, with two panels each, ran continuously. The weathering chamber time clock indicated a starting time/clock at 38,329 hours and ended at 43,794 hours. In addition, the second panels were respectively ended at the same end hours (43,794 hours). The first panels tested were concluded and measured at 5,465 hours total exposure (227 days) continuous. The second pair of coated panels were stopped at the same date concluding at 5,004 hours (208 days) of total time for testing.

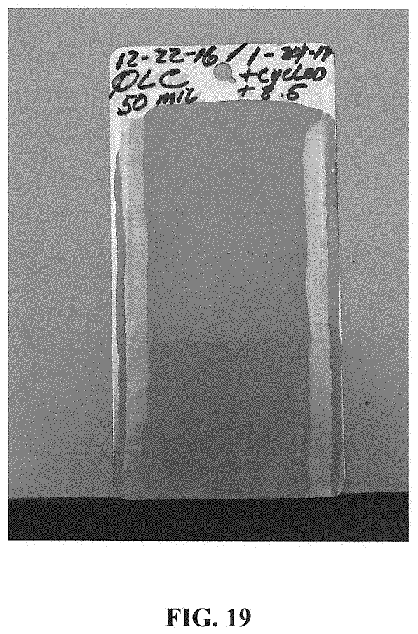

The results of the test showed a slight color shift as shown in FIG. 19, which is a photograph of the coated Q-Panel after 227 days. Additionally, as also shown in FIG. 19, it was observed that the test coupon showed some slight dulling of the test coating compared to the unexposed portion of the Q-Panel. The adhesion remained unaffected, and the elongation of the coating was observed to be unchanged as well, when compared to the unexposed side of the panel. Overall, the test coating offered exceptional resistance to the QUV Weathering Test. The samples showed little to no degradation during the entire test procedure, validating that the test coating is stable for prolonged UVA exposure.

### Watch Glass Chemical Resistance Test

Another test that was performed on the test coating was the Watch Glass Chemical Resistance Test, which was performed in order to determine the chemical resistance of the formulated coating to various harsh chemicals.

As part of this test, each test panel had the test coating spray applied using an HVLP spray gun to an approximate wet film thickness of 60-80 mils. The samples were allowed to cure for approximately 5 days. Individual 6″×6″ x ¼″ concrete panels were spray coated with 40 mils of PLC coating, then each panel was treated with 15 to 20 drops of each chemical. The treated area was then covered with a 76.2 mm watch glass and sealed with silicone grease to keep the chemicals from evaporating. The panels were then exposed to the following acidic/caustic/chemical materials: Sodium Hydroxide, Hydrochloric Acid, Phosphoric Acid, Methanol, Nitric Acid, Kerosene, and Gasoline. Each sample was exposed long term to each material as indicated in Table 6 below.

TABLE 6

| Material | Duration | Associated FIG. |
|---|---|---|
| 10% Sodium Hydroxide | 281 days | 20 |
| 20% Sodium Hydroxide | 281 days | 20 |
| 30% Sodium Hydroxide | 281 days | 20 |
| 10% Hydrochloric Acid | 281 days | 21 |
| 20% Hydrochloric Acid | 281 days | 21 |
| 10% Phosphoric Acid | 281 days | 22 |
| 20% Phosphoric Acid | 281 days | 22 |
| Methanol | 281 days | 23 |
| 10% Nitric Acid | 281 days | 24 |
| 20% Nitric Acid | 281 days | 24 |
| Kerosene | 131 days | 25 |
| Gasoline | 58 days | 26 |
| Aromatic 100 | 131 days | 27 |

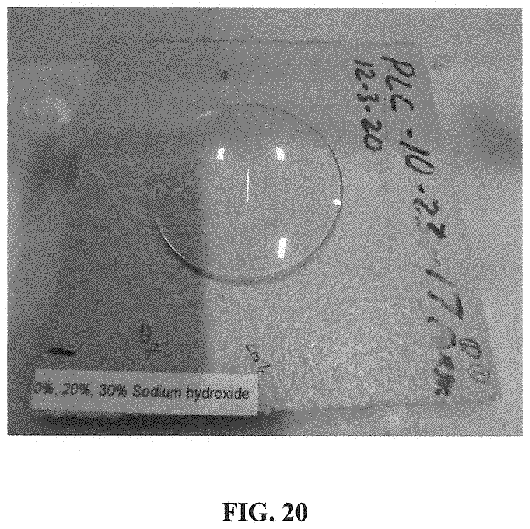

At the end of the test, the test coating was inspected for any visual degradation and checked for cleaving of the linkage of hydrogen bonds and other forms of chemical induced polymer bond dissociation. The test coating offered great resistance to the materials provided above with the exception of the hydrocarbon solvents. The test coatings softened due to hydrocarbon affinity with the hydrocarbon solvent based coating. After the hydrocarbon solvent evaporated, the test coating returned to its former coating properties as well as its toughness and elongation were preserved. The samples showed little to no degradation during the entire test procedure. FIGS. 20-27 are photographs of the test samples, as explained in Table 6, showing the results of the testing.

What is claimed is:

1. A protective liner coating comprising:
a first solvent, wherein the first solvent comprises C9-C11 aromatic hydrocarbons;
a second solvent, wherein the second solvent comprises a nature-based terpene solvent;
a third solvent;
an antioxidant;
a first pigment, wherein the first pigment comprises an inorganic pigment;
barium sulfate;
a wetting agent, wherein the wetting agent comprises modified polyacrylate fluorocarbon-modified polymers;
a rheological additive, wherein the rheological additive comprises attapulgite clay;
a surfactant, wherein the surfactant comprises a non-reactive silicone glycol copolymer surfactant;
a second pigment, wherein the second pigment comprises a liquid pigment; and
a plurality of resins.

2. The protective liner coating of claim 1, wherein the third solvent comprises PCBTF.

3. The protective liner coating of claim 1, wherein the antioxidant comprises a sterically-hindered primary phenolic antioxidant stabilizer.

4. The protective liner coating of claim 1, wherein the first pigment comprises titanium dioxide.

5. The protective liner coating of claim 4, wherein the titanium dioxide comprises rutile titanium dioxide.

6. The protective liner coating of claim 1, wherein the barium sulfate comprises a grade in the range of 4 to 15 microns.

7. The protective liner coating of claim 1, wherein the plurality of resins comprises a first resin, a second resin, and a third resin.

8. The protective liner coating of claim 7, wherein the first resin comprises a SEBS resin.

9. The protective liner coating of claim 7, wherein the second resin comprises a hydrogenated hydrocarbon resin.

10. The protective liner coating of claim 7, wherein the third resin comprises a hydrocarbon resin.

11. A protective liner coating comprising:
a first solvent having a wt. % in the range of 10 wt. % to 15 wt. %;
a second solvent having a wt. % in the range of 10 wt. % to 15 wt. %;
a third solvent;
an antioxidant having a wt. % in the range of 0.30 wt. % to 0.50 wt. %;
a first pigment having a wt. % in the range of 10 wt. % to 15 wt. %;
barium sulfate having a wt. % in the range of 10 wt. % to 15 wt. %;
a wetting agent having a wt. % in the range of 0.8 wt. % to 1.0 wt. %;
a rheological additive having a wt. % in the range of 0.10 wt. % to 0.20 wt. %;
a surfactant having a wt. % in the range of 0.4 wt. % to 0.6 wt. %;
a second pigment having a wt. % in the range of 0.10 wt. % to 0.25 wt. %; and
a plurality of resins having a wt. % in the range of 24 wt. % to 28 wt. %.

12. The protective liner coating of claim 11, wherein the protective liner coating further comprising a fourth resin.

13. The protective liner coating of claim 12, wherein the fourth resin comprises a chlorinated polyester resin.

14. The protective liner coating of claim 11, wherein the protective liner coating further comprises a non-slip, abrasion enhancement additive.

15. The protective liner coating of claim 11, wherein the protective liner coating further comprises strengthening fibers.

16. A method for making a protective liner coating comprising:
providing a tank and a mixer;
adding a first solvent and a second solvent to the tank;
mixing the first solvent and the second solvent in the tank;
adding the following additional materials to the tank: an antioxidant, a first pigment, barium sulfate, a wetting agent, a rheological additive, a surfactant, and a second pigment;
adding a plurality of resins to the tank; and
adding a third solvent to the tank.

17. The method of claim 16, wherein the additional materials added to the tank are added in the following order: the antioxidant, the first pigment, the barium sulfate, the wetting agent, the rheological additive, the surfactant, and the second pigment.

18. The method of claim 16, wherein the method further comprises conducting a quality control test.

19. The method of claim 16, wherein the method of making the protective liner coating takes from 3 hours to 4 hours.

20. The method of claim 16, wherein the plurality of resins comprises a SEBS resin, a hydrogenated hydrocarbon resin, and a hydrocarbon resin.
